(19) United States
(12) Patent Application Publication
(10) Pub. No.: US 2003/0036962 A1
(43) Pub. Date: Feb. 20, 2003

(54) Delivery to current location of user determined using real-time location access information of user

(76) Inventor: Laurence E. Holt, London (GB)

Correspondence Address: LAW OFFICES OF MICHAEL DRYJA, 704 228TH AVENUE NE, PMB 694, SAMMAMISH, WA, 98074, US

(21) Appl. No.: 09/682,316

(22) Filed: Aug. 19, 2001

(51) Int. Cl. G06F 17/60

(52) U.S. Cl. 705/26; 705/1

(57) ABSTRACT

The delivery of an order to the current location of the user who had placed the order, using real-time location access information of the user, is disclosed. The user makes an order for one or more tangible, physical items, providing therewith a number of locations at which the user can receive the order, as well as real-time location access information of the user. A deliverer, at time of delivery, determines the current location of the user from the locations provided by the user, using the real-time location access information provided by the user. The deliverer delivers the order to the user at his or her current location as has been determined.

### BACKGROUND OF INVENTION

This invention relates generally to the delivery of items, such as physical, tangible items, and more particularly to the delivery of such items to the current location of the user who had previously ordered them.

Today more people than ever are placing orders for and receiving delivery of items, as opposed to going to a store to purchase and take home the items themselves. People may place orders online on the Internet or over email, by fax, or by telephone. However, receiving delivery of their orders is problematic, given the increasingly mobile nature of people. For instance, in the past, there usually was one person of a household home at all times, so delivery was simply a matter of delivering an order to the home address of a user, since someone was always likely to be there.

Today, however, frequently no one is home during regular business hours Monday through Friday to accept delivery. Whereas delivery could be made by just leaving the order on a doorstep, this is impractical for expensive items that the person who had placed the order is worried will be stolen. Furthermore, delivery could be made to a neighbor who is at home during the day, but this is inconvenient, especially where the person does not maintain cordial relations with his or her neighbors. For these and other reasons, therefore, there is a need for the present invention.

### SUMMARY OF INVENTION

The invention relates to delivery of an order to the current location of the user who had placed the order, using real-time location access information of the user. The user makes an order for one or more tangible, physical items, providing therewith a number of locations at which the user can receive the order, as well as real-time location access information of the user. A deliverer, at time of delivery, determines the current location of the user from the locations provided by the user, using the real-time location access information provided by the user. The deliverer then delivers the order to the user at his or her current location as has been determined. The invention thus achieves a deliver-to-me concept.

The invention provides for advantages not found within the prior art. The user may, for example, provide a home address, a work address, as well as a second home address as the locations at which the user can accept delivery. The user may also provide the times at which he or she is likely to be at these various locations. The real-time location access information of the user may be a phone number, an email address, or an instant message address of the user, or position-locating technology information of the user, such as global positioning system (GPS) information or mobile phone-based position-locating technology information.

When the deliverer is ready to make delivery, the current location of the user is determined by using the real-time location access information. Thus, the user who had placed the order does not have to worry about delivery being made when the user is not at home, since the deliverer only attempts delivery to the current location of the user, within the confines of the locations at which the user indicated he or she would accept delivery. Still other aspects, advantages, and embodiments of the invention will become apparent by reading the detailed description, and by referring to the accompanying drawings.

### BRIEF DESCRIPTION OF DRAWINGS

FIG. 1 is a flowchart of a method according to an embodiment of the invention.

FIG. 2 is a flowchart of a method showing how the deliverer can determine the user's current location by email, phone, or instant message.

FIG. 3 is a diagram showing how the deliverer can determine the user's current location by using global positioning system (GPS) technology.

FIG. 4 is a diagram showing how the deliverer can determine the user's current location by using mobile phone-based position-locating technology.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

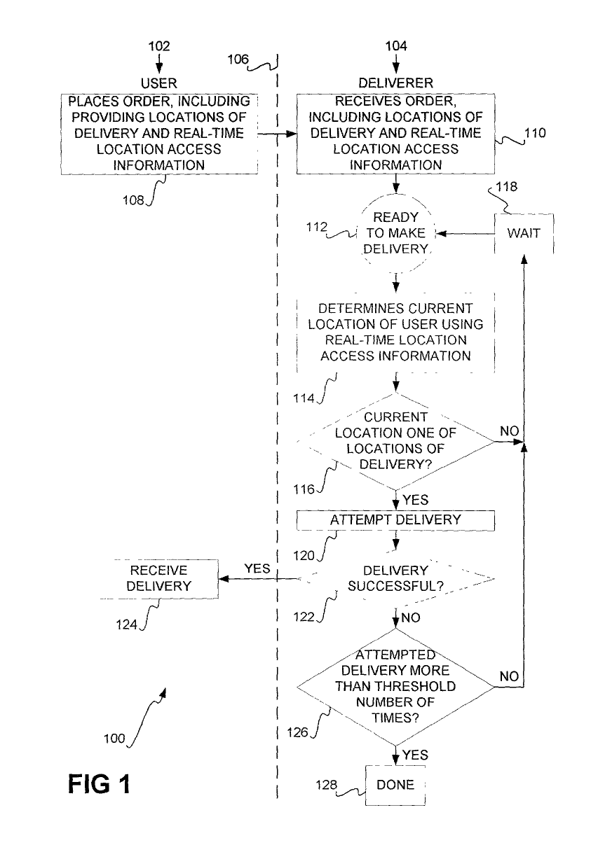

FIG. 1 shows a method 100 according to an embodiment of the invention. Various parts of the method 100 are performed by the user and the deliverer, as indicated by the columns 102 and 104, respectively, separated by the dotted line 106. The user places an order, including providing therewith locations at which the user is willing to accept delivery of the order, as well as real-time location access information (108). The order is for one or more physical, tangible items, such as letters, packages, groceries, rental cars, and so on. This is as compared to non-physical, intangible items, such as information received over email or otherwise received electronically. The user may place the order online on a web site, by email, by fax, by telephone, or by another manner.

The order may be placed directly with the deliverer, or may be placed with another entity, such as a company that accepts orders, but uses a delivery company to actually deliver the items ordered. In any case, ultimately the deliverer receives the order, including the locations of delivery and the real-time location access information specified by the user (110). At some point, the deliverer is ready to make delivery (112). This may because the items ordered by the user are now in stock, or the deliverer, in sequentially processing all orders received, has reached the user's order, and so on.

The deliverer determines the current location of the user, using the real-time location access information provided by the user when he or she previously placed the order (114). The real-time location access information generally refers to information that enables the deliverer to determine the current location of the user. Such information may include the user's phone number, such as a home, work, or mobile number, the user's email address, the user's instant message address, and so on. This information may require active involvement of the user in order to for the deliverer to ascertain the user's current location.

The information may also be more sophisticated, and include information by which the user's current location can be determined by global positioning system (GPS), or by wireless-based position-locating technology, where the latter such technology may use a mobile phone or another type of device. Such information does not require the active involvement of the user in order for the deliverer to ascertain the user's current location. Furthermore, such passive-determining information is generally referred to as position-locating technology information, in that a technology device of the user enables the deliverer to determine the user's location, without active involvement by the user. However, the user may still be aware of the deliverer's attempt to determine his or her location, even though the user is not actively involved in this attempt.

Once the deliverer has determined the user's current location, it determines whether this current location is one of the locations that the user had previously specified as that at which the user is willing to accept delivery (114). The user may in providing these locations also have provided the times and days during which the user is usually at the locations, to guide the deliverer in making the delivery. Furthermore, where the user is actively involved in the deliverer's ascertaining his or her current location, the user may indicate that he or she is amenable to delivery of the order to his or her current location, regardless of whether this current location is one of the locations that the user previously specified as that at which the user is willing to accept delivery.

Thus, if the current location is one of the locations the user previously specified, or if the user is otherwise willing to accept delivery at his or her current location (116), then delivery of the item(s) ordered by the user is attempted by the deliverer (120). However, if the current location is not one of the locations that the user has specified, and if the user is not otherwise willing to accept delivery at his or her current location (116), then the deliverer waits for a duration of time (118), until it is ready to attempt to make delivery again (112), as has been described.

Delivery may be successful or unsuccessful. Delivery of the order may still be unsuccessful, even though the deliverer knows the current location of the user, because some time lag typically still occurs between when the deliverer has determined the user's current location, and when the deliverer reaches this location. Where the user was actively involved in the deliverer determining the user's current location, the user may choose or be requested to wait at the current location until delivery is made, lessening the chances for unsuccessful delivery. However, especially where the user was not actively involved in the deliverer determining the user's current location, the user may no longer be at the location the deliverer determined as his or her current location by the time the deliverer reaches this location. In such instances, delivery would be unsuccessful.

If delivery is successful (122), then the user receives delivery of the item(s) that he or she has previously ordered (124), and the method 100 is finished. However, if delivery is unsuccessful (122), and the deliverer preferably has not attempted delivery more than a threshold number of times (126), then the deliverer again waits for a duration of time (118), until it is ready to make delivery again (112), as has been described. If delivery is unsuccessful (122), and the deliverer preferably has attempted delivery more than a threshold number of times (126), then the deliverer may choose to not attempt delivery further, such that the method ends (128). The deliverer may follow an alternate course of action, where the item is sent to a default location or address, without the deliverer first determining whether this is the current location of the user.

The wait times in 118 preferably vary depending on whether 118 is performed after 116, in which the user is at a location not previously specified by the user, or whether 118 is performed after 126, in which the delivery attempt was unsuccessful. For instance, after 116, the waiting duration in 118 may be a long duration, such as an hour. However, if a delivery attempt was unsuccessful, the waiting duration in 118 after 126 may be a short duration, such as even zero minutes, where redetermining the user's location is immediately performed.

Furthermore, the user may be currently in transit, even though initially he or she was at a valid location. This may potentially cause the deliverer to follow the user around, without ever successfully making the delivery. To avoid this scenario, the delivery could use the location information to determine whether the user is in transit. For example, the deliverer could compare two sets of location information separated by a short interval, such as a short number of minutes, to do this. If the user is determined to be in transit, then the deliverer does not attempt to make a delivery.

The locations provided by the user can be specific locations, or they can more generally be a local service area for a delivery company, which is the area handled by a particular depot or other type of service station for the delivery company, from which trucks bearing packages depart. For example, for New York City, the user may specify the Manhattan, Madison Square local service area. When the order arrives at this local service area, the deliverer may then locate the user within the local service area. Furthermore, the locations provided by the user may be stored in a profile for the user, such that the user only has to enter in the information once, and can use this information for subsequent orders placed by the user.

The user may also potentially provide different locations that are in different location service areas for the delivery company. For instance, for New York City, the user may specify a Manhattan office and a Brooklyn residence, which likely lie in different local service areas. The deliverer is faced with the potential problem of not knowing to which location to route the ordered item for ultimate delivery to the user. For instance, the order may arrive at a local airport, at which point the deliverer must route the order to a particular local service area based on the different locations specified by the user.

To accommodate this situation, in one embodiment the deliverer contacts the user when the order has arrived at a point where the deliverer must determine to which of a number of different location service areas to route the order for ultimate delivery to the user. The deliverer may inquire to the user that delivery will be made within the next day or other time period, and ask the user from which location service area he or she wishes delivery to occur. For instance, if the user is on vacation and at home, the user is likely to specify the local service area encompassing his or her residence, whereas if delivery is to occur during the week when the user is at work, the user is likely to specify the local service area encompassing his or her office. The inquiry to the user may take the form of interactive contact with the user, such as by phone, email, chat, and so on, but could also be accomplished by assessing the user's current location, and resolving the location to a local service area. The invention is not particularly limited to any such approach, however.

Alternatively, the deliverer may use the location information provided by the user at the time of the order, where this information includes the times at which the user is likely to be at each specified location. From a predicted time of delivery, the deliverer can then route the order to the most appropriate local service area. For example, if the deliverer predicts that delivery will occur in the evening, then the order may be routed to the local service area encompassing the user's residence, since the user may have specified that he or she is likely to be at home during the evening. The deliverer may also determine to which local service area to route the order based on a combination of asking the user and predicting where the user is likely to be during delivery.

Furthermore, each time delivery is unsuccessful where the locations provided by the user are in different local service areas of the deliverer, the deliverer preferably determines whether delivery should be retried within the same local service area, or whether the order should be routed to another local service area from which to attempt delivery. For instance, for New York City, the deliverer may have initially determined that delivery should be attempted within a Manhattan local service area, based on predicting that the user will be at his or her office at the likely delivery time. However, after one or more unsuccessful delivery attempts within this local service area, the deliverer may then conclude that delivery should be attempted from a Brooklyn local service area, such that the order is routed to this new local service area.

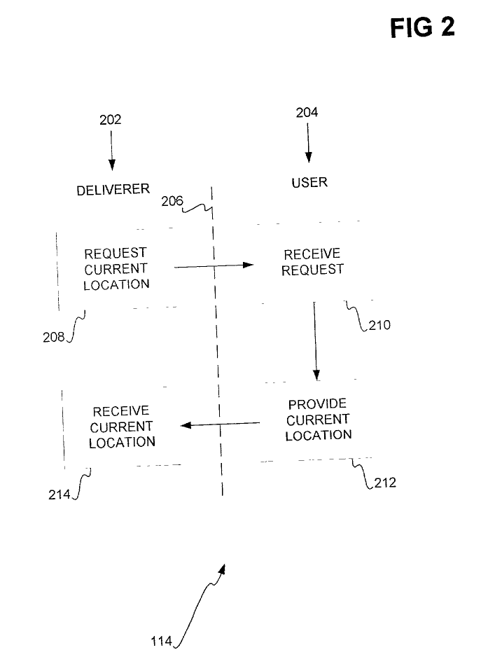

FIG. 2 shows the performance of 114 of FIG. 1 in more detail, where the user has provided real-time location access information that requires his or her active involvement in order for the deliverer to determine the current location of the user. Various parts of the method 114 are performed by the deliverer and the user, as indicated by the columns 202 and 204, respectively, separated by the dotted line 206. The deliverer requests that the user provide his or her current location (208). Where the user has provided an email address as the real-time location access information, this can involve the deliverer emailing its request to the user. Where the user has provided an instant message address, this can involve the deliverer sending an instant message including its request to the user. Where the user has provided a phone number, this can involve the deliverer calling the user at this phone number to make its request.

The user ultimately receives the request (210), and in response, provides his or her current location (212). The user may also indicate whether he or she is amenable to receiving delivery at this current location, regardless of it not being one of the locations that the user previously indicated as that which he or she is amenable to receiving delivery. The response provided by the user is preferably sent in the same form in which the user received the deliverer's request. So where the user received an email, he or she preferably sends an email in response. Where the user received an instant message, he or she preferably sends an instant message in response. Where the user received a phone call, in the same phone conversation he or she indicates his or her current location. The deliverer then receives the user's current location as specified by the user (214).

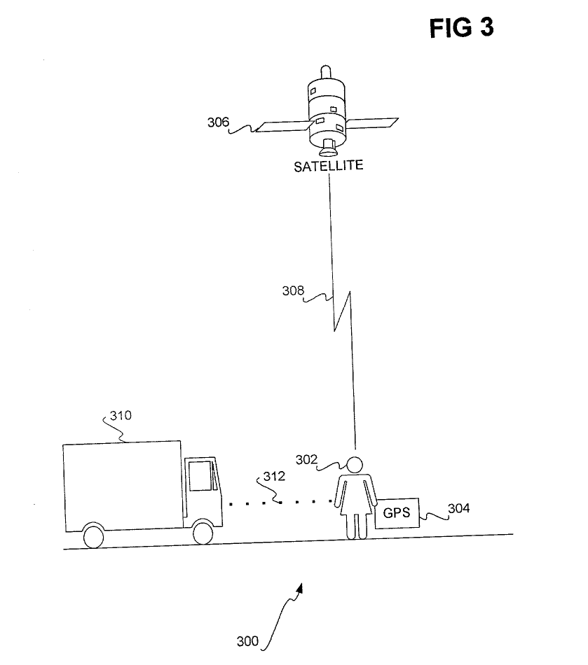

FIG. 3 shows a diagram 300 illustrating an embodiment of the invention in which the real-time location access information includes position-locating technology information, specifically GPS information regarding the user. The user 302 has a GPS device 304. The GPS device 304 in conjunction with one or more satellites, such as the satellite 306, and preferably three such satellites, determines the user's current position, or location, as indicated by the line 308. This current location of the user is then relayed to the deliverer, represented by the truck 310, as indicated by the dotted line 312.

The truck 310 may have a device that communicates wirelessly with a similar device of the user 302 that reads the user's current location from the GPS device 304 as determined in conjunction with the satellite 306, and relays this location back to the truck 310. Alternatively, a device of the user 302 may communicate with a central device, such as a mobile phone tower, which reads the user's current location from the GPS device 304 as determined in conjunction with the satellite 306, and relays this location back to the central device. The truck 310 may then have a device that checks with this central device to determine the current location of the user, or the central device may relay the current location of the user automatically to the truck 310.

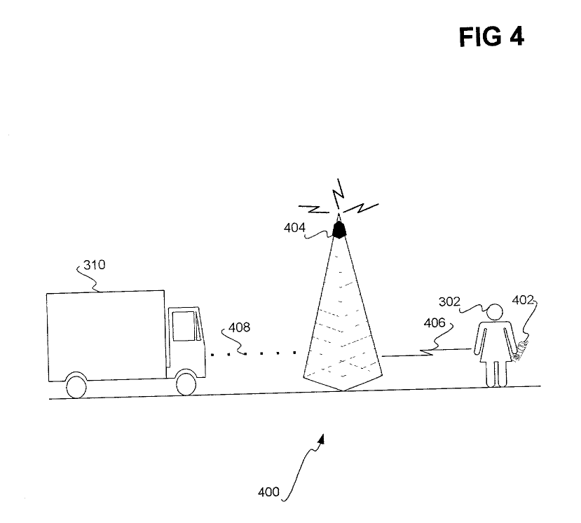

FIG. 4 shows a diagram 400 illustrating an embodiment of the invention in which the real-time location access information includes position-locating technology information, specifically mobile phone-based position-locating technology information. The user 302 has a mobile phone 402, by which one or more mobile phone towers, such as the tower 404, can determine the user's current location, as indicated by the line 406. This current location of the user is then relayed to the deliverer, again represented by the truck 310, as indicated by the dotted line 408. The truck 310 may itself have a mobile phone or other device that communicates wirelessly with the tower 404 to request and receive this information from the tower 404. The user 302 may have the option to allow the truck 310 to receive this information, or the truck 310 may always be allowed to receive the current location of the user as determined by the tower 404.

It is noted that, although specific embodiments have been illustrated and described herein, it will be appreciated by those of ordinary skill in the art that any arrangement is calculated to achieve the same purpose may be substituted for the specific embodiments shown. This application is intended to cover any adaptations or variations of the present invention. For example, whereas the deliverer is represented in several of the figures as a truck, this is for illustrative purposes only, and does not represent a limitation on the invention itself. That is, other types of delivery approaches, inclusive of or in lieu of truck-based delivery, are also amenable to the invention. Therefore, it is manifestly intended that this invention be limited only by the claims and equivalents thereof.

1. A method comprising:
a user making an order for one or more tangible, physical items, providing therewith a plurality of locations at which the user can receive the order and real-time location access information;
a deliverer determining at time of delivery a current location of the user from the plurality of locations by using the real-time location access information provided by the user when making the order; and,
the deliverer delivering the order to the user at the current location of the user that has been determined.

2. The method of claim 1, wherein the real-time location access information comprises an instant message address of the user.

3. The method of claim 2, wherein the deliverer determining at the time of delivery the current location of the user comprises sending an instant message to the user at the instant message address of the user.

4. The method of claim 1, wherein the real-time location access information comprises an email address of the user.

5. The method of claim 4, wherein the deliverer determining at the time of delivery the current location of the user comprises sending an email to the user at the email address of the user.

6. The method of claim 1, wherein the real-time location access information comprises a phone number of the user.

7. The method of claim 6, wherein the deliverer determining at the time of delivery the current location of the user comprises calling the user at the phone number of the user.

8. The method of claim 1, wherein the real-time location access information comprises position-locating technology information of the user.

9. The method of claim 8, wherein the position-locating technology information of the user comprises global positioning system (GPS) information regarding the user.

10. The method of claim 8, wherein the position-locating technology information of the user comprises wireless-based position-locating technology information of the user.

11. The method of claim 8, wherein the deliverer determining at the time of delivery the current location of the user comprises locating the user using the position-locating technology information of the user.

12. A method comprising:
a user making an order for one or more tangible, physical items, providing therewith a plurality of locations at which the user will receive the order and real-time location access information;
repeating
a deliverer repeatedly determining a current location of the user by using the real-time location access information provided by the user until the current location of the user is one of the plurality of locations at which the user will receive the order; and,
the deliverer attempting delivery of the order to the user at the current location of the user that has been determined,
until one of two conditions occurs: the deliverer has successfully delivered the order to the user; and, the deliverer has attempted delivery a threshold number of times without successfully delivering the order to the user.

13. The method of claim 12, wherein the real-time location access information comprises an instant message address of the user, and the deliverer determining the current location of the user comprises sending an instant message to the user at the instant message address of the user.

14. The method of claim 12, wherein the real-time location access information comprises an email address of the user, and the deliverer determining the current location of the user comprises sending an email to the user at the email address of the user.

15. The method of claim 12, wherein the real-time location access information comprises a phone number of the user, and the deliverer determining the current location of the user comprises calling the user at the phone number of the user.

16. The method of claim 12, wherein the real-time location access information comprises position-locating technology information of the user, and the deliverer determining the current location of the user comprises locating the user using the position-locating technology information of the user.

17. The method of claim 16, wherein the position-locating technology information of the user comprises one or more of: global positioning system (GPS) information regarding the user; and, wireless-based position-locating technology information of the user.

18. A method comprising:
a deliverer receiving a plurality of locations at which a user will receive an order for one or more tangible, physical items previously made by the user;
the deliverer determining a current location of the user by using position-locating technology information of the user; and,
the deliverer delivering the order to the user when the current location of the user is one of the plurality of locations at which the user will receive the order.

19. The method of claim 18, wherein the position-locating technology information of the user comprises at least global positioning system (GPS) information regarding the user.

20. The method of claim 18, wherein the position-locating technology information of the user comprises at least wireless-based position-locating technology information of the user.
